(19) United States
(12) Patent Application Publication
(10) Pub. No.: US 2007/0151296 A1
(43) Pub. Date: Jul. 5, 2007

(54) METHOD AND APPARATUS FOR HANDLING AND ALIGNING GLASS SUBSTRATES

(75) Inventors: Jun Young Huh, Cupertino, CA (US); Sung Tae Park, Jeonju (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Photon Dynamics, Inc., San Jose, CA (US)

(21) Appl. No.: 11/614,042

(22) Filed: Dec. 20, 2006

Related U.S. Application Data
(60) Provisional application No. 60/753,917, filed on Dec. 22, 2005.

(51) Int. Cl. C03B 11/08; C03B 18/00

(52) U.S. Cl. 65/29.12; 65/182.2

(57) ABSTRACT

A chuck adapted to support a substrate includes an array of glass bars spaced apart and each having a number of holes in its supporting surface. The holes in the supporting surfaces are connected to a common conduit that is supplied with air to provide an air cushion to support the substrate during loading and positioning operations. Scrubbers in contact with one or more edges of the substrate are used to locate the substrate precisely relative to a mechanical reference. After the substrate is positioned at the desired location, the common conduit is separately supplied with vacuum to provide a suction force to hold the substrate to the chuck. The array of glass bars are designed to operate in conjunction with a multi-light backlight system that provides uniform illumination for areas of the substrate that are supported above a glass bar as well as for areas of the substrate that are positioned between the glass bars.

### CROSS-REFERENCES TO RELATED APPLICATIONS

The present application claims the benefit under 35 U.S.C. § 119(e) of U.S. Provisional Patent Application No. 60/753,917, filed on Dec. 22, 2005, entitled “Method and Apparatus for Handling and Aligning Glass Substrates,” which is incorporated herein by reference in its entirety.

### BACKGROUND OF THE INVENTION

The present invention relates generally to glass handling and positioning systems. More specifically, the present invention relates to methods and apparatus for supporting a substrate on an air cushion provided by an array of glass bars.

In the FPD (flat panel display) industry, the size of the glass plates used in fabricating FPDs has increased as the market demand for larger displays, such as TV screens 40 inches in size or larger, has grown. In accordance with these market demands, FPD manufacturers have increased the size of the glass plates (or panel glass) used in the manufacturing process. Generation 7 glass plates, for example, are approximately 1870 mm by 2200 mm in size, while Generation 9 glass plates are expected to be approximately 2400 mm by 2700 mm. While the glass plates increase in area with each generation, they remain roughly the same thinness, approximately 0.5 mm to 1 mm.

Conventional array repair machines (also referred to as array saver machines) have used a lift-pin mechanism during the glass plate loading and unloading process. Typically, the panel glass is laid on a flat chuck surface during review and repair processes. There are a number of conventional approaches to loading, aligning, and unloading the glass plates. One such method uses a one-piece chuck, roughly the same size as the glass plate. A number of lift-pin holes are usually included through the top surface of the chuck, and lift-pin mechanisms accept the glass plate as it is presented by a factory robot. An air cushion is required to float the glass plate to enable alignment. As chuck sizes have increased, it has become more difficult to drill these distribution holes and system for such an air cushion in a single-body, solid chuck. For example, a long gun-drill may be used to form the conduits connecting the distribution holes in the chuck. In addition, single-body, solid chucks have large surface area contact with the glass plates. This provides opportunity for particulates to be trapped between the glass plates and chuck, or for exchange of unwanted electrostatic discharge (ESD) from the chuck to the glass plates. Further, in the application of defect review, it is beneficial to view defects with illumination coming through the plate (that is, backlighting). A solid chuck, unless it is made of a transparent material, does not permit backlighting. A solid chuck made of a transparent material, such as glass, cannot be easily machined with an air distribution system, and for the plate sizes of interest will be quite expensive. Therefore there is a need in the art for improved methods and systems for supporting and positioning glass substrates for test, inspection, and/or repair.

### SUMMARY OF THE INVENTION

According to one embodiment of the present invention, a chuck adapted to support a substrate includes an array of glass bars spaced apart and each having a number of holes on its supporting surface. The holes in the supporting surfaces are connected to a common conduit that is supplied with air to provide an air cushion between the substrate and chuck so that the substrate can be supported above the chuck during loading and positioning operations. No lift-pins are utilized and the lack of contact between the backside of the substrate and the glass bars during loading reduces the risk of particle generation that would otherwise result from contact between the backside of the substrate and the lift-pins or with the supporting surfaces of the glass bars. Accordingly, direct loading of substrates with a potentially faster exchange rate and with a lower risk of electrostatic discharge is achieved.

While the substrate is supported on the air cushion, scrubbers in contact with one or more edges of the substrate are used to locate the substrate precisely relative to a mechanical reference. After the substrate is positioned at the desired location, the common conduit is separately supplied with vacuum to provide a suction force to hold the substrate to the chuck. Thus, the conduit is in fluid communication with either pressurized gas or vacuum at different stages of the loading/inspection/unloading process.

The array of glass bars are designed to operate in conjunction with a multi-light backlight system used for test processes, inspection processes, and the like. Uniform illumination is directed from the backside of the substrate (and passes through the substrate in some cases) using the backlight system. The illumination is the same for areas of the substrate that are supported above a glass bar as well as for areas of the substrate that are supported by the air cushion at positions between the glass bars. Accordingly, even defect illumination is achieved, either with or without the glass bar below the target defect area.

### BRIEF DESCRIPTION OF THE DRAWINGS

FIG. 1A is a simplified schematic illustration of an inspection and repair system according to an embodiment of the present invention;

FIG. 1B is a simplified perspective view of a backlight illumination module mounted on a swing arm according to an embodiment of the present invention;

FIG. 2 is a simplified schematic illustration of a support chuck for an inspection and repair system according to an embodiment of the present invention;

FIG. 3 is a simplified schematic illustration of a support chuck during a panel glass loading operation according to an embodiment of the present invention;

FIGS. 4A-4C are simplified schematic illustrations of a support member according to an embodiment of the present invention;

FIGS. 5A-5B are simplified schematic illustrations of a support member according to another embodiment of the present invention;

FIGS. 6A-6D are simplified schematic illustrations of positioning members according to an embodiment of the present invention; and

FIG. 7 is a simplified side-view illustration of a backlight illumination module according to an embodiment of the present invention.

### DETAILED DESCRIPTION OF SPECIFIC EMBODIMENTS

A chuck adapted to support a substrate includes an array of glass bars spaced apart and each having a number of holes in its supporting surface. The holes in the supporting surfaces are connected to a common conduit that is supplied with air to provide an air cushion to support the substrate during loading and positioning operations. Scrubbers in contact with one or more edges of the substrate are used to locate the substrate precisely relative to a mechanical reference. After the substrate is positioned at the desired location, the common conduit is separately supplied with vacuum to provide a suction force to hold the substrate to the chuck. The array of glass bars are designed to operate in conjunction with a multi-light backlight system that provides uniform illumination for areas of the substrate that are supported above a glass bar as well as for areas of the substrate that are positioned between the glass bars.

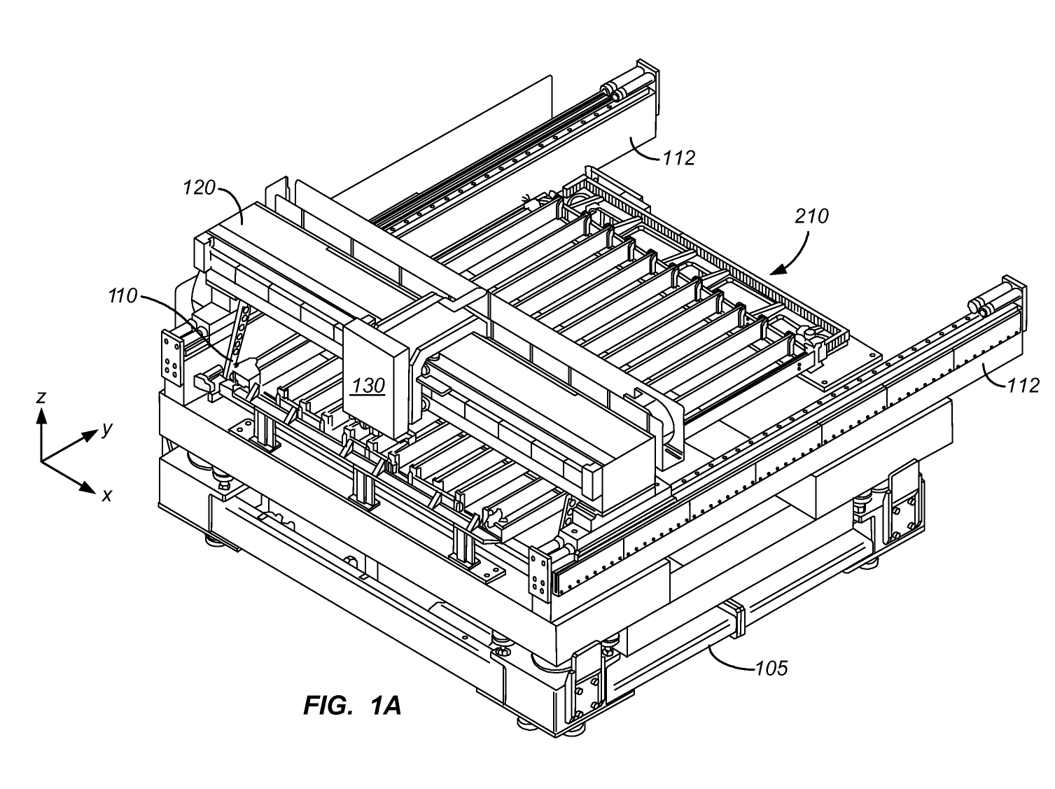

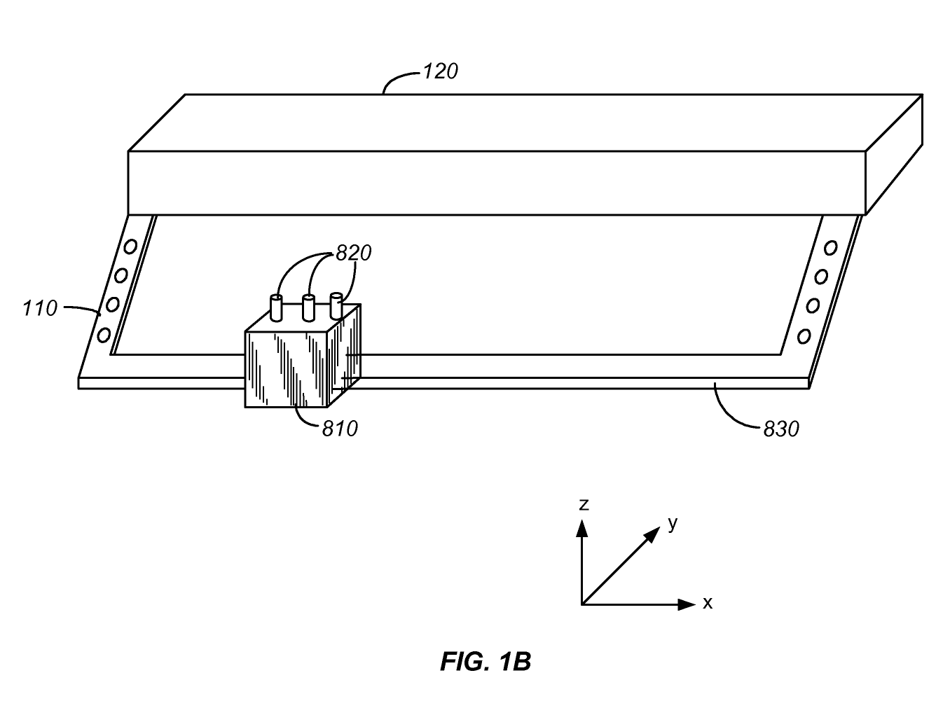

FIG. 1A is a simplified schematic illustration of an inspection and repair system according to one embodiment of the present invention. As illustrated in FIG. 1A, a supporting structure 105, generally including a granite base, is adapted to provide mechanical support for several components of the inspection and repair system. Two rails 112 located at opposite edges of the supporting structure 105 extend the length of the supporting structure. A gantry 120 is mounted on the rails and is operated under computer control to move to predetermined positions along the rails, thereby positioning one or more inspection and/or repair heads 130 along the length (y) of the system. Additionally, the inspection/repair head 130 is moved in the x-direction along the gantry under computer control. Accordingly, by translating the head 130 in both x and y directions, the head is positioned over a selected portion of a panel glass resting on top of support chuck 210.

In addition to the inspection/repair head 130, embodiments of the present invention provide a swing arm 110 mounted to the underside of the gantry. As illustrated in FIGS. 1A and 1B, the swing arm includes a cross bar 830 extending along the width of the system in the x-direction and underneath the support chuck 210. Additional inspection equipment, such as a backlight module 820 in FIG. 1B, is attached to the swing arm and is able to be positioned at selected positions underneath panel glass resting on the support chuck 210. The backlight includes a number of optical sources 820, and is configured to move along the swing arm cross bar 830 in the x-direction. Accordingly, the backlight module may be positioned under a selected portion of a plate positioned in the x-y plane between the gantry 120 and the backlight module 810. Light from the optical sources 820 propagates in a direction with a component along the z-direction, passing through the plate and impinging on the one or more inspection and/or repair heads 130 mounted on the gantry 120.

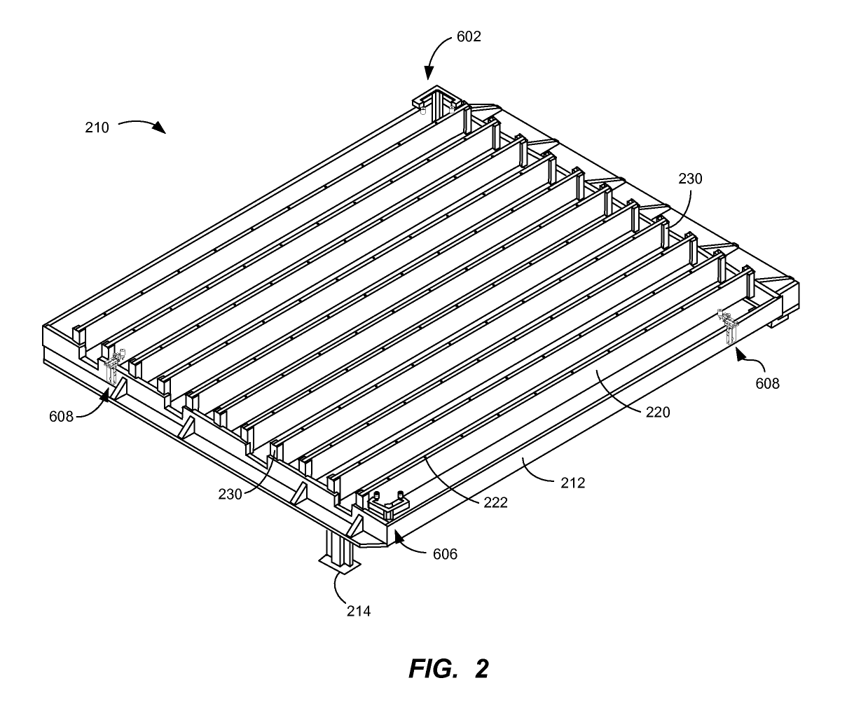

FIG. 2 is a simplified schematic illustration of a support chuck for an inspection and/or repair system according to an embodiment of the present invention. As shown, the glass handling platform 210 includes a chuck frame 212 rigidly mounted on the supporting structure (105 in FIG. 1A) through the use of a number of chuck supports 214. The chuck supports may be fixed to mounting plates attached to a granite stage that provides for system stability and rigidity. The chuck frame 212 is sized to provide support for additional plate members that are adapted in accordance with the dimensions of panel glass under test, the inspection and/or repair systems utilized, and the stroke and range of actuators used to translate and position the inspection and/or repair systems. Moreover, the chuck frame is designed to provide a rigid support structure for the mounting of plate support members as described below, including providing adjustable positioning for the support members and maintaining a desired flatness tolerance across the dimensions of the support members.

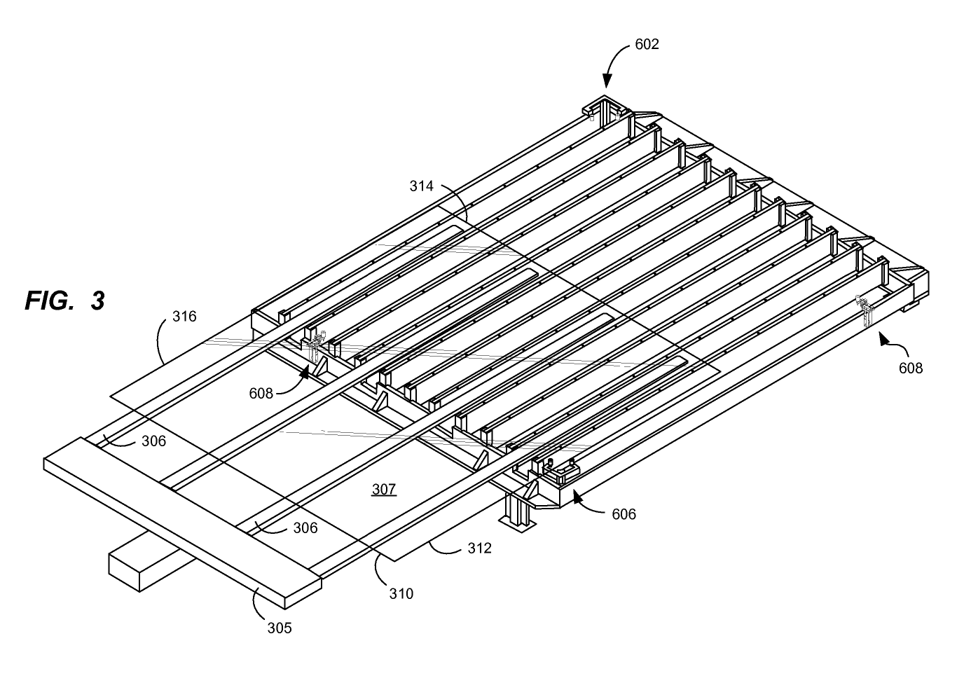

A number of plate support members 220 are arrayed in parallel and attached to the chuck frame 212. The plate support members 220 are precisely aligned and mounted to the chuck frame to support a flat, large, thin sheet of glass (illustrated in FIG. 3), such as a glass plate used in manufacturing FPDs. The support members include a distribution system that may either carry air or draw vacuum through the top surfaces facing the panel glass. The distribution system includes holes passing through the top surfaces of the support members that are connected to a common conduit or cross channel which is coupled at one or both ends of the member to a source of positive pressure gas and a source of negative pressure gas, with a suitable switching mechanism that allows either positive pressure gas to form an air cushion or a negative pressure gas (vacuum) to hold the glass plate in place. Test operations are also included within the scope of embodiments of the present invention and may utilize a single glass bar and a fixed backlight module.

As illustrated, the array of plate support members forms a grill for supporting the panel glass to be tested/repaired. The number of plate support members 220 is selected based on size of the panel glass to provide sufficient support for the panel glass while reducing the contact area between the support members and the panel glass. In the particular embodiment illustrated in FIGS. 2 and 3, 11 support members are shown. For larger glass plate sizes, the number of support members may be more, and for smaller glass plate sizes, the number may be smaller. The spacing between support members is determined, in part, by the size of the panel glass, the dimensions of the robot arm, and the sag or variation in the z-direction allowed between members by the inspection and or repair optics. A typical suitable area ratio of the space between the support members to the surface area of the top of the support members is approximately greater than 2:1.

At the end of each plate support member, a support and leveling bracket 230 is provided and used to align and maintain the support members in a fixed position with respect to each other and to the chuck frame. The support members top surfaces are aligned to lie in a plane with approximately 0.01 mm tolerance. The flatness of the plate under test is preferably maintained within a tolerance less than the depth of focus or equivalent z-position parameter of the inspection and repair systems. For some inspection and repair systems manufactured by Photon Dynamics, Inc., this tolerance window is approximately 0.15 mm. Therefore, the positioning and sag of the support members are controlled in some embodiments to position the plate under test within this tolerance window.

As more fully described below, a number of plate positioning and adjustment members are illustrated in FIGS. 2 and 3. At two corners, corner positioning members 602 and 606 are provided. In embodiments of the present invention, the corner positioning members 602 and 606 differ and provide particular benefits. Additionally, edge positioning members 608 may be provided along two sides of the chuck frame. As illustrated, the positioning members are mounted on the chuck frame. One of ordinary skill in the art would recognize many variations, modifications, and alternatives.

FIG. 3 is a simplified schematic illustration of a support chuck during a panel glass loading operation according to an embodiment of the present invention. Robot 305, which is part of the customer's manufacturing line, includes a predetermined number of arms 306 that support panel glass 307. In the specific embodiment illustrated in FIG. 3, four arms are provided on the robot, although this is not required by the present invention. The robot carries panel glass to and from other parts of the customer's factory to the tool. The robot arms are characterized by a width less than the space between adjacent support members. Thus, the spaces between the support members of the support chuck allow room for the robot arms to position the plate above the support members, lower the plate, placing the plate on the support members, and thereafter retract. Utilizing the space between the support members and optional cutouts in the chuck frame, the robot is able to translate a predetermined distance in the vertical direction so that the robot arms can be retracted after depositing the plate on the support members.

Generally, the robot arm picks up a plate at a first location (not shown), transports the plate to a position above the support members, and lowers the plate to a position resting on an air cushion provided by the support members. As illustrated in FIG. 3, the robot arms are inserted approximately half of the length of the chuck frame and at a height above the top of the support members. After the robot arms extend fully into the chuck frame, the robot arms lower the plate onto the air cushion provided by the perforations 222 in the top of the support members so that the robot arms are free from contact with the plate. The robot is then retracted at a level below the upper plane of the support members. After placement and alignment of the plate, the plate is brought into contact with the support members by application of a vacuum through the conduits within the support members to the backside of the plate.

During unloading operations, this sequence of events is reversed. The vacuum is switched off and air is applied to float the plate while the robot arms are inserted. The robot arms lift the plate off the support members, and then retract and remove the plate from the inspection/repair system. Thus, the invention makes use in some embodiments of positive and negative gas pressure behind the glass plate, alignment mechanisms, and/or the robot's z-motion to load, position, and unload the plate.

Numerous benefits are provided using the direct glass loading concept. In conventional designs, lift-pins actuated by a mechanical linkage are often used to support the panel glass prior to contact with components of the chuck frame. The mechanical linkage lowers the glass plate after the robot is retracted. Additionally, lift-pins are used to lift the panel glass, separating the plate from the chuck surface after inspection and/or repair operations. Some embodiments of the present invention eliminate the requirement for lift-pins. In addition, by eliminating the lift-pins, the direct glass loading action eliminates any time associated with lift-pin movement, thus reducing overall load and unload time and increasing throughput. The elimination of lift-pins has the further benefit of reducing ESD that may be generated during the separation of the plate from the chuck surface by the lift-pins in conventional arrangements. Further, the total surface contact area between the support members and the glass plate is significantly less than the total glass plate surface, which reduces the opportunity for transfer of contamination or rubbing of the glass plate by support members, and reduces the opportunity for ESD between the glass plate and chuck members. Further, if support members are fabricated from glass or a transparent material, the direct glass loading concept described herein allows the implementation of a back illumination system that may move below the chuck.

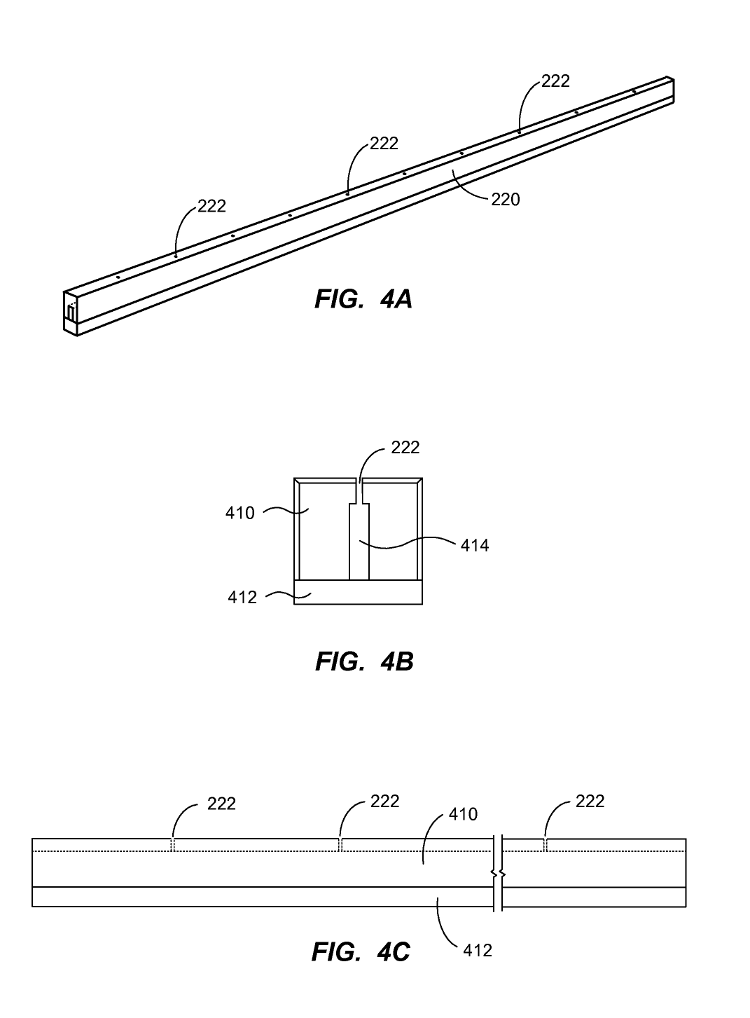

As noted above, in accordance with embodiments of the present invention, gas distribution paths are provided within a support member. Accordingly, a number of holes are provided passing through the surface of each glass bar adjacent the glass plate and are connected by a common conduit along the full length of the support member, to which a delivery line from the positive pressure and the negative pressure sources may be connected. FIGS. 4A-4C illustrate a support member and it associated holes and conduit in accordance with one embodiment of the present invention. FIG. 4A is a simplified perspective view of a support member 220, FIG. 4B is an end-view of the support member, and FIG. 4C is a side-view of the support member. Support member 220 comprises a top section 410 and a bottom section 412. A groove 414 is formed in a first side of the top section 410 to form an air supply channel along the length of the glass bar. Further, a predetermined number of air holes or perforations 222 are formed in the top section 410 of the support member (glass bar) at positions along the length of the support member. The top of the glass bar must generally be substantially planar to ensure that the panel glass supported by the glass bar is also substantially planar.

Generally, the spacing between adjacent holes is uniform since the weight of the plate under inspection/repair is generally uniform as a function of lateral position. Thus, in an embodiment, the air holes are drilled at a uniform interval, although this is not required by the present invention. Additionally, the holes are generally centered with respect to the width of the bar as illustrated in FIG. 4B, although this is not required by the present invention. The size and number (correlated with the density) of air holes is determined based on the air pressure selected for the system as well as the weight of the plates supported by the air cushion provided by the support members.

As illustrated in FIGS. 4B and 4C, positioning the bottom piece 412 opposed to the groove 414 in piece 410 forms the gas supply conduit or channel along the length of the glass bar. Generally, the top and bottom sections are bonded together using clear optical glue. One of skill in the art will appreciate the various techniques available to bond glass members, including anodic bonding, eutectic bonding, plasma activated covalent wafer bonding, and the like. In some bonding processes, the portions of the support member are cleaned, rinsed and dried. The parts to be bonded may be subsequently exposed to an oxygen, argon, or other plasma species to plasma activate the glass surfaces. Bonds between the various sections of the support member should preferably provide microscopic bonds that can withstand thermal stress associated with temperature change during transportation as well as mechanical stress exerted due to gravitational force, air and vacuum pressure in the supply channel, and loading/unloading of the panel glass.

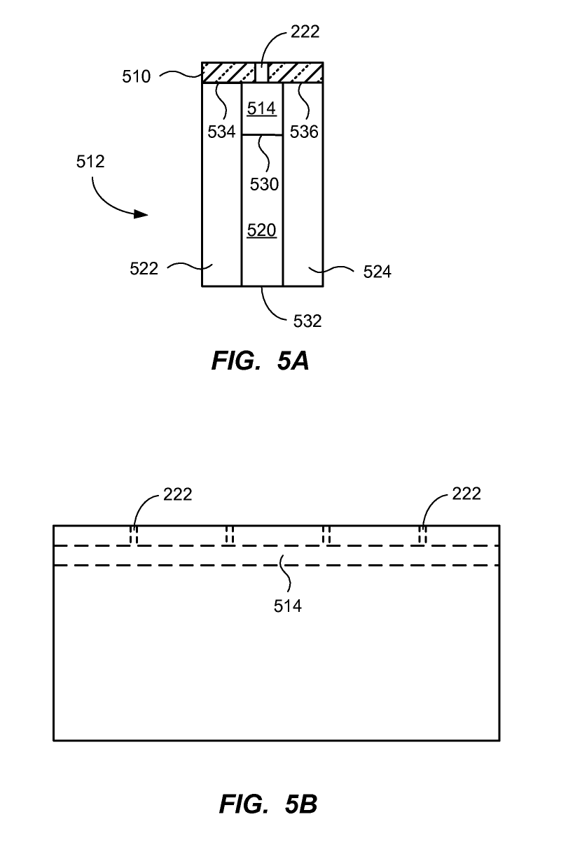

FIGS. 5A-5B illustrate another possible approach for formation of a lengthwise conduit connecting holes through the top surface of a support member. FIG. 5A is an end-view of the support member 220 and FIG. 5B is a side-view of the support member 220. In this embodiment the support member includes four sections. The top section 510 includes a predetermined number of air holes or perforations 222 formed along the length of the bar. The supply channel 514 is formed by sandwiching a central section 520 between two outer sections 522 and 524 to form a lower section 512. The lower section and the top section 510 are joined, thereby forming the supply channel 514. As illustrated in FIG. 5A, the outer sections are taller than the central section, providing a supply channel 514 running the length of the glass bars. The supply channel formed using a central section 520 is preferably polished on at least one of the top 530 or bottom 532 side of central section, improving the optical quality of these surfaces compared to surfaces generally resulting from machining operations. In addition, the top surfaces 534 and 536 of the outer sections and/or the portions of section 510 abutting the outer sections and the supply channel are also preferably polished. As discussed in more detail below, in backlight testing operations, these polished surfaces provide high quality optical surfaces that maximize backlight transmission. In yet other embodiments, various surfaces of the support member may include polished chamfered edges or may be optically coated (e.g., with an anti-reflection coating) to reduce optical losses resulting from reflection at interfaces.

A specific example of the embodiment shown in FIGS. 4A-4C or FIGS. 5A and 5B may include a support member having a length of approximately 2300 mm and a width of approximately 19.5 mm. The height may be approximately 115 mm. Holes through the top surface may be approximately 1 mm in diameter, and may be spaced by approximately 3 cm. The conduit may be approximately 6 mm in width and 1 cm deep. The surface of the support member that contacts the glass plate may have flatness of approximately 0.01 mm. Other widths, lengths, heights, surface flatness of the support member may be used. Further, other channel sizes and hole sizes and spacing may be employed.

For applications in which back illumination is desired, the support members may be made of transparent materials such as clear borosilicate glass (BSG). BOROFLOAT® 33, available from Schott North America, Inc., of Louisville, Ky. may be used. Moreover, as discussed above, surfaces of the BSG bars are polished and/or coated to provide optical quality surfaces that minimize the optical differences across the chuck frame, namely between the support members and the air gaps between adjacent support members.

With respect to both types of support members illustrated in FIGS. 4A-4C and 5A-5B, each section of the support members can be divided into more sections if such subdivision results in better machining quality and/or manufacturability. One of ordinary skill in the art would recognize many variations, modifications, and alternatives.

Although not illustrated in FIG. 2, at either one end or both ends of the support members, a pneumatic fitting may be provided that is in fluid communication with a supply of clean dry air (CDA) and/or a source of vacuum.

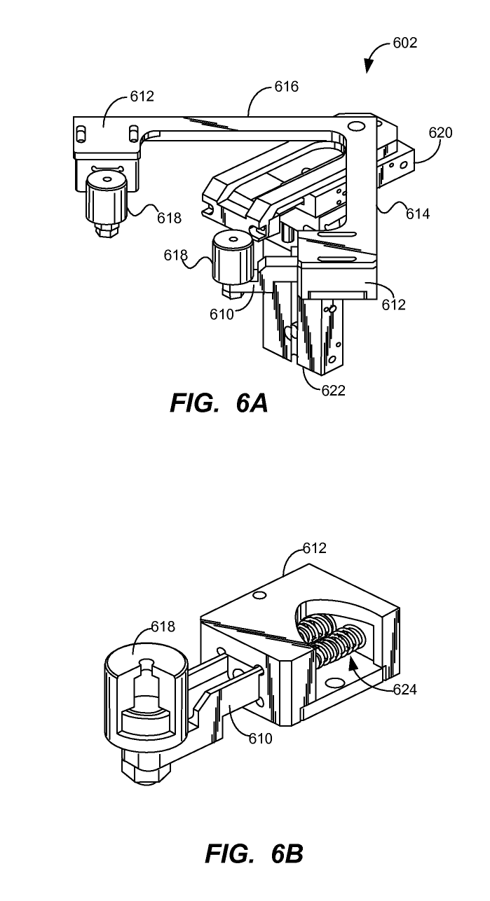

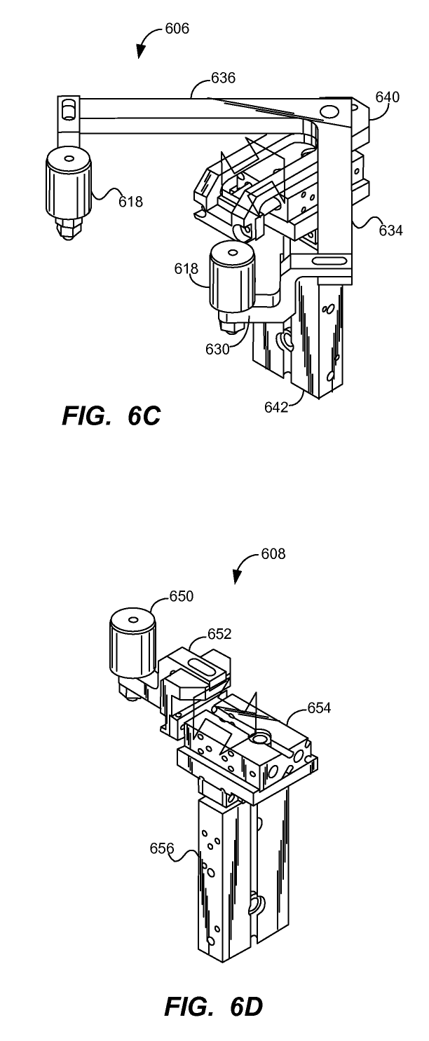

According to some embodiments of the present invention, pneumatic scrubbers (sometimes called aligners or pushers) are utilized to align panel glass supported on the air cushion above the support members. In FIG. 2, flexible position scrubber 602 and fixed position scrubbers 606 and 608 are mounted on the chuck frame 212. FIGS. 6A-6D are simplified schematic illustrations of positioning members according to one embodiment of the present invention.

In FIG. 6A, a flexible corner positioning member 602 has two extension arms 610 with flexible couplings 612 mounted on corner supports 614 and 616. The corner supports are two portions of a single “L” shaped bracket. Thus, the flexible couplings 612 are geometrically tied together in a fixed relationship to each other, enabling a single drive mechanism to translate both caps 618 simultaneously. The single “L” shaped bracket including the corner supports is mounted on a horizontal air cylinder 620, which is coupled to a vertical air cylinder 622. The vertical air cylinder is adapted to position the caps 618 at a vertical position aligned with the panel glass supported above the support members 220. The horizontal air cylinder is adapted to position the caps at a predetermined horizontal position, which will be brought into contact with two edges of the panel glass as described more fully below.

FIG. 6B illustrates the flexible couplings 612 that connect the caps 618 to the corner supports 614 and 616. The cap may be mounted on an extension arm 610 that is coupled to one or more springs 624 mounted in the flexible couplings. Although FIG. 6B illustrates the use of springs, other flexible members are included within the scope of the present invention. In other embodiments, grommets or bushings are utilized in place of the springs illustrated in FIG. 6B. During positioning operations, contact between the edge of the panel glass and the cap will result in a force directed along the length of the extension arm, compressing the springs mounted in the flexible coupling. Depending on the characteristics of the springs, embodiments of the present invention provide a predetermined amount of linear compensation to account for initial misalignment in the position of the panel glass.

FIG. 6C illustrates a corner positioning member 606 with fixed position caps. As shown, two extension arms 630 are mounted on corner supports 634 and 636, which are two portions of a single “L” shaped bracket, in a fixed position with respect to the corner supports. Thus, the extension arms 630 and caps 618 are geometrically tied together in a fixed relationship to each other, enabling a single drive mechanism to translate both caps 618 simultaneously. The single “L” shaped bracket including the corner supports is mounted on a horizontal air cylinder 640, which is coupled to a vertical air cylinder 642. The vertical air cylinder is adapted to position the caps 618 at a vertical position aligned with the panel glass supported above the support members 220. The horizontal air cylinder is adapted to position the caps at a predetermined horizontal position, which will be brought into contact with two edges of the panel glass as described more fully below.

FIG. 6D illustrates an edge positioning member 608 with a fixed position cap 650. Extension arm 652 is mounted in connection with a horizontal air cylinder 654, which provides for motion of the cap along the longitudinal axis of the air cylinder, and a vertical air cylinder 656. The horizontal and vertical air cylinders are adapted to position the cap at a predetermined horizontal and vertical position, which will be brought into contact with an edge of the panel glass as described more fully below.

During a positioning operation, the panel glass is first loaded onto the chuck frame, and an air cushion is provided below the plate. The corner positioning member 606 and two edge positioning members 608 are moved to predetermined positions using their corresponding vertical and horizontal air cylinders actuated under computer control. Generally, the motion of the fixed positioning members 606 and 608 will translate the panel glass if the initial position of the panel glass is such that contact is made between the positioning members and the plate. In some embodiments, depending on the initial position of the panel glass after placement on the chuck by the robot, the motion of the corner positioning member 606 and the edge positioning members 608 to their predetermined positions may not result in contact between the caps and the panel glass.

Referring to FIG. 6A, because the plate is supported on the air cushion provided by the support members 220, the plate can be moved with minimal force by the flexible positioning member 602 using its corresponding vertical 622 and horizontal 620 air cylinders to position caps 618 in contact with a first side 314 and a second side 316 of the panel glass (as shown in FIG. 3). Preferably, the flexible positioning member 602 pushes the panel glass into contact with the fixed position caps, resulting in contact between the fixed positioning member 606 and a third side 310 and a fourth side 312 of the panel glass. Contact will also be made between the fixed side positioning members 608 and the third and fourth sides of the panel glass.

Generally, after contact between positioning members 606 and 608 and the third side 310 and the fourth side 312 of the panel glass, the springs present in the flexible couplings of positioning member 602 are compressed. Thus, the panel glass is scrubbed or positioned at a predetermined location suitable for subsequent inspection and/or repair operations. The motion of the corner and edge positioning members to predetermined positions may be performed sequentially, concurrently, simultaneously, or combinations thereof, depending on the particular applications.

Using some embodiments of the present invention, the number of contact points between the alignment and positioning members and the panel glass is reduced from eight contact points (two on each side of the panel glass) to six contact points (four fixed and two flexible). Additionally, the use of the “L” shaped brackets illustrated in FIGS. 6A and 6C reduces the number of horizontal drives from six to four (i.e., air cylinders 620 and 640 at opposite corners and air cylinders 654 on two sides). Moreover, some embodiments of the present invention provide for the placement of the four hard stops at a predetermined or scrubbing position, followed by translation of the panel glass using the flexible positioning member at a scrubbing corner to align and position the panel glass at a predetermined position. Typically, the positioning members are adapted to receive panel glass from the robot with position variations of up to ±5 mm. Thus, the range of the scrubbing operations provided by the positioning members is greater than 5 mm. Embodiments of the invention may use any number of contact points in any combination of fixed and flexible alignment and positioning members.

The above sequence of steps are merely illustrative and are not intended to limit embodiments of the present invention. In alternative embodiments, the number of steps in the positioning or scrubbing process, the order of the steps, and delays between various steps are modified depending on the particular application. Other alternatives can also be provided where steps are added, one or more steps are removed, or one or more steps are provided in a different sequence without departing from the scope of the claims herein.

The ability to review and repair metal lines and other features in the circuitry formed on the panel glass in a backlight mode is a desirable feature in inspection and/or repair equipment. Some conventional chuck designs employ a single piece glass for the chuck, enabling backlighting of the plate. However, with increasing size of panel glass comes increasing difficulty in the machining of a piece of glass appropriately sized to function as a chuck for current generation panel glass. Thus, embodiments of the present invention provide a chuck design that is compatible with backlight inspection and/or repair operations.

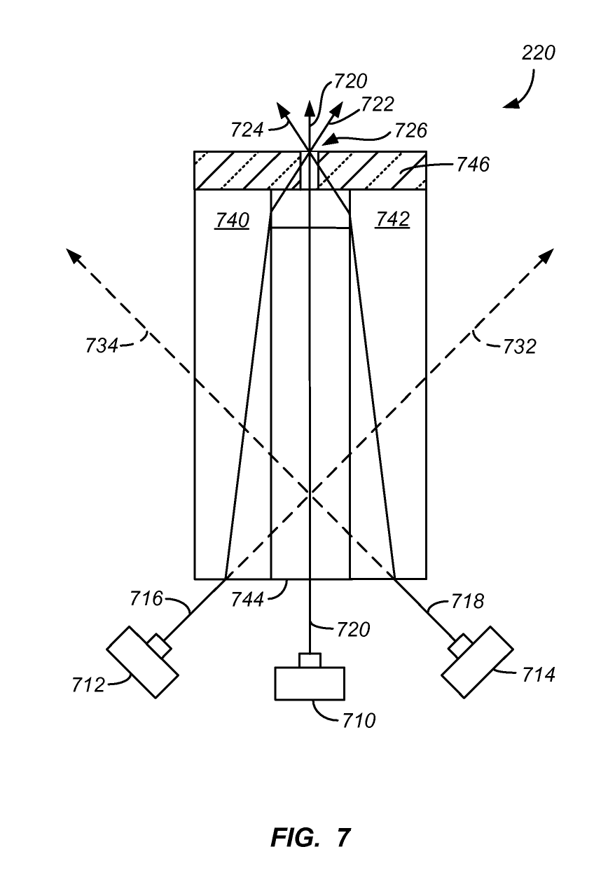

FIG. 7 is a simplified illustration of a backlight illumination module according to an embodiment of the present invention. As illustrated in FIG. 7, a number of light sources 710, 712, and 714 are located below the support member 220. The light sources used in some embodiments are light emitting diode (LED) sources available from Lumileds of San Jose, Calif. These particular sources are characterized by a radiometric power of 66 to 80 mW emitted over a wavelength range of about 420 nm to about 700 nm. Depending on the particular applications, sources providing sufficient optical illumination at appropriate wavelengths may be utilized.

Also shown in FIG. 7 is a support member 220 such as those described with reference to FIGS. 5A and 5B with three light sources positioned below. A panel glass 750 is supported by the support members 220 (one shown in FIG. 7), and is partially in contact with the top surface of support member 220 and partially not in contact.

During testing and/or repair operations, the surface of the plate is scanned for defects by the inspection/repair head 130 as shown in FIG. 1A. For those applications in which a backlight is utilized for the inspection/repair operation, the backlight assembly movement is coordinated with the inspection/repair head 130 to ensure consistent illumination at any point on the surface of the plate. Thus, the test, inspection, and/or repair operations that utilize backside illumination are assured that illumination through the support member is equivalent in intensity and distribution to illumination that is carried through free space and impinges directly onto the back of the panel glass. FIG. 7 may represent both of these two conditions. Typically, the difference between intensity of illumination in free space and intensity of illumination through the glass support member is less than 25%.

For the condition in which the illumination crosses through free space, the light from light source 710 propagates along line 720 and impinges on the plate at the intersection point 726. For this condition, the light rays 720, 722, 724, 732, and 734 are merely illustrative. Optics used for focusing, reflection, and the like are omitted for purposes of clarity. Further, the light from light sources 712 and 714 will propagate along rays 732 and 734, respectively, passing away from the area under test. Thus, the intensity of the light at the area under test will be a function of the intensity of light ray 720, the corresponding optics, and the like.

For the condition with the support member positioned between the light sources and the area under test, light from light source 710, which is mounted at normal incidence to the lower surface of section 744, propagates along the same direction as in the first condition, passing through section 744, the supply channel above section 744, and section 746. After passing through these sections and the supply channel, the light from light source 710 impinges on the plate at location 726. In the embodiment illustrated in FIG. 7, light from light sources 712 and 714 refracts at the outer surfaces of sections 740 and 742, respectively, passing through the top section 746. The geometry of the support member and the sources, together with the optical properties of the support member are selected so that light from sources 712 and 714 impinges at location 726 when the support member is positioned between the sources and the plate under test.

Embodiments of the present invention are not limited to the particular geometry shown in FIG. 7. In other embodiments, the material properties of the sections of the support member result in other angles of refraction. Additionally, the emission from the light sources is not constrained to lie in a single plane, but may lie in several planes, while still intersecting at a location associated with the area under test. Moreover, the sizes of the various sections, the angles of incidence selected for the various light rays, the coatings provided on various surfaces of the support member sections, and the like may impact the amount of light impinging on the area under test. One of ordinary skill in the art would recognize many variations, modifications, and alternatives.

In alternative embodiments, the light sources may be aligned along a line that is perpendicular to the arrangement illustrated in FIG. 7, that is, the light sources may be along a line that runs parallel to the length of the support members. In these embodiments, the three light sources generally propagate through one of the lower sections 740, 742, or 744 as well as through the upper section 746 when the area under test is positioned above the respective section. At the interfaces of the various sections, light propagates through the corresponding materials as will be evident to one of skill in the art.

An alternative embodiment of the invention useful for testing operations may include a single glass bar containing an array of holes in its top surface and connected by a single conduit for air and vacuum. The surface area of such single glass bar is smaller than the total area of the glass plate under test, inspection, or repair. A backlighting module may be employed that is either fixed or movable. Thus, although some embodiments described herein utilize an array of glass bars, this is not required, as other embodiments utilize a single glass bar.

While the present invention has been described with respect to particular embodiments and specific examples thereof, it should be understood that other embodiments may fall within the spirit and scope of the invention. The scope of the invention should, therefore, be determined with reference to the appended claims along with their full scope of equivalents.

What is claimed is:

1. A substrate handling system comprising:
a chuck frame;
a chuck coupled to the chuck frame, the chuck comprising an array of glass bars spaced apart by a predetermined distance, each glass bar of the array of glass bars having perforations in a support surface adapted to contact a backside surface of a substrate, wherein the perforations in each glass bar are in fluid communication with a conduit extending along a length of that glass bar; and
a multi-light backlight system adapted to illuminate the backside surface of the substrate.

2. The substrate handling system of claim 1 wherein the conduit is in fluid communication with a source adapted to provide a pressurized gas and a source adapted to provide a vacuum.

3. The substrate handling system of claim 2 wherein the pressurized gas comprises air.

4. The substrate handling system of claim 1 wherein each glass bar is a borosilicate glass bar.

5. The substrate handling system of claim 1 wherein one or more surfaces of each glass bar are coated with an anti-reflection coating.

6. The substrate handling system of claim 1 wherein the support surface of each glass bar is substantially planar.

7. The support member of claim 6 wherein the conduit comprises a single bore having a machined surface and passing through an interior portion of each glass bar.

8. The support member of claim 6 wherein each glass bar further comprises a glass base plate having a bonded surface.

9. The substrate handling system of claim 1 further comprising one or more scrubbers adapted to contact one or more edges of the substrate.

10. The substrate handling system of claim 9 wherein the one or more scrubbers comprises:
a first stop coupled to the chuck frame; and
a second stop coupled to the chuck frame.

11. The substrate handling system of claim 10 further comprising a third stop mounted on a side support coupled to the chuck frame, wherein the third stop is characterized by a fixed spatial relationship to the side support.

12. The substrate handling system of claim 1 wherein the multi-light backlight system and the array of glass bars are adapted to provide a light intensity at a first portion of the substrate positioned above each glass bar and substantially a same light intensity at a second portion of the substrate positioned between each glass bar.

13. The substrate handling system of claim 12 wherein the light intensity at the first portion and the substantially same light intensity at the second portion differ by less than 25%.

14. The substrate handling system of claim 1 wherein the multi-light backlight system comprises:
a first light source emitting optical radiation along at least a first direction, wherein the optical radiation from the first light source impinges on a test area of the substrate, and
a second light source emitting optical radiation along at least a second direction, wherein the first direction and the second direction are related by a first angle and refraction of light from the second light source passing through each glass bar causes optical radiation from the second light source to impinge on the test area.

15. A method of positioning a glass plate on a flat panel display test, inspection, and/or station, the method comprising:
providing an air cushion by flowing a gas through a plurality of perforations provided in an upper surface of one or more glass bars;
positioning the glass plate on the air cushion;
contacting one or more edges of the glass plate with one or more scrubbers;
moving the glass plate to a predetermined position using the one or more scrubbers; and
holding the glass plate in contact with the upper surface of the one or more glass bars after the moving step.

16. The method of claim 15 wherein positioning the glass plate on the air cushion comprises transferring the glass plate from a robot arm to a position adjacent the one or more glass bars.

17. The method of claim 15 wherein moving the glass plate comprises translating the glass plate in at least a horizontal direction.

18. The method of claim 15 wherein holding the glass plate comprises providing a vacuum at the upper surface of the one or more glass bars by creating a pressure less than an atmospheric pressure in a conduit formed inside the one or more glass bars.

19. A method of inspecting, repairing, or testing a glass plate adapted for use in LCD displays, the method comprising:
providing an air cushion by flowing a gas through a plurality of perforations in an upper surface of one or more glass bars;
positioning the glass plate on the air cushion;
drawing the gas through the plurality of perforations to place a backside of the glass plate in contact with the upper surface of the one or more glass bars; and
illuminating the backside of the glass plate.

20. The method of claim 19 further comprising:
contacting one or more edges of the glass plate with one or more scrubbers; and
moving the glass plate to a predetermined position using the one or more scrubbers.

21. The method of claim 20 wherein moving the glass plate to a predetermined position is performed free from contact between the backside of the glass plate and the upper surface of the one or more glass bars.

22. The method of claim 19 wherein the gas is a pressurized gas provided to the plurality of perforations using a conduit extending along a length of each of the one or more glass bars.

23. The method of claim 22 wherein drawing the gas through the plurality of perforations comprises applying a vacuum source to the conduit.
